(19) United States
(12) Patent Application Publication
(10) Pub. No.: US 2014/0091886 A1
(43) Pub. Date: Apr. 3, 2014

(54) OPERATING MECHANISM

(71) Applicant: Naoki Tanaka, Tokyo (JP)

(72) Inventor: Naoki Tanaka, Tokyo (JP)

(73) Assignee: MITSUBISHI ELECTRIC CORPORATION, Chiyoda-ku (JP)

(21) Appl. No.: 14/119,731

(22) PCT Filed: Aug. 29, 2011
(86) PCT No.: PCT/JP2011/069423

§ 371 Date: Nov. 22, 2013

(30) Foreign Application Priority Data
Jun. 9, 2011 (JP) 2011-129109

(51) Int. Cl. H01H 3/28; H01H 89/00

(52) U.S. Cl. CPC H01H 3/28; H01H 89/00
USPC 335/1

(57) ABSTRACT

A shutter plate that is supported so as to be able to swing in both directions and covers both first and second operating parts, and a shutter mechanism that operates the shutter plate in one direction when the first operating part is to be exposed and in reverse direction when the second operating part is to be exposed are provided, wherein the shutter mechanism includes one pair of locking members for limiting or releasing the swing of the shutter plate.

### TECHNICAL FIELD

The present invention relates to an operating mechanism that is used for, for example, a three-position switch operating mechanism in which shutter functions of a disconnecting switch and an earthing switch are integrated into one shutter.

### BACKGROUND ART

For example, in a conventional three-position switch operating mechanism, a shutter for switching the operation between a disconnecting switch operating part and an earthing switch operating part is rotated by rotating a rotation shaft of the shutter using a special shutter operating lever to be attached to the rotation shaft.

### CITATION LIST

### Patent Literature

PTL 1: JP-A-2006-228673

### SUMMARY OF INVENTION

### Technical Problem

In the conventional operating mechanism for operating the shutter as above, the special shutter operating lever is needed for switching the operation between the disconnecting switch operating part and the earthing switch operating part, and, specifically, the special shutter operating lever needs to be attached to the rotation shaft and then manually rotated. In order to do this, the shutter operating lever needs to be managed so as not to be lost. Furthermore, attaching the shutter operating lever to the rotation shaft is an extra work.

### Solution to Problem

An operating mechanism in accordance with the invention includes: a shutter plate that is swingably supported by a swing shaft held by a mechanism body, covers both a first operating part and a second operating part placed in parallel to each other on the mechanism body; and a shutter mechanism that, in exposing the first operating part to operate the first operating part, swings the shutter plate in one direction and, in exposing the second operating part to operate the second operating part, swings the shutter plate in reverse direction, wherein the shutter mechanism includes one pair of locking members for limiting or releasing the swing of the shutter plate, wherein the shutter mechanism includes: first and second cams that move in conjunction with the shutter plate; and first and second limit switches that are opened and closed by the first and second cams, respectively, to control the protruding/retracting operation of one pair of plungers that can be protruded and retracted with respect to the shutter plate, wherein both the plungers normally limit the swing of the shutter plate to maintain the first operating part and the second operating part covered, and wherein, in operating the first operating part or the second operation part, in order to expose the operation part to be operated, when the shutter plate reaches a predetermined swing angle, the plunger for the operation part to be operated is retracted by the first cam and first limit switch or the second cam and second limit switch to release the limitation of the swing of the shutter plate.

### Advantageous Effects of Invention

A three-position switch operating mechanism employing the operating mechanism of the invention provides an effect in which: the shutter plate and the cams are integrally formed to allow operation without backlash in the contact operation of the limit switch by the cams; the shutter functions of both the operating parts are integrated into one shutter to allow reduction in the number of parts; and the operation of the shutter is integrated to one point to allow improvement in operability and allow any appropriate contact operating position to be set.

### BRIEF DESCRIPTION OF DRAWINGS

FIG. 1 A front view showing a three-position switch operating mechanism in accordance with a first embodiment of the invention.

FIG. 2 A front view in which a shutter plate is removed from FIG. 1.

FIG. 3 A cross-sectional view taken along the line A-A in FIG. 1.

FIG. 4 An exploded perspective view of an assembled shutter mechanism.

FIGS. 5A-5D Diagrams illustrating an operation angle of the shutter plate when a disconnecting switch is operated.

FIGS. 6A-6D Diagrams illustrating an operation angle of the shutter plate when an earthing switch is operated.

FIG. 7 An circuit diagram showing a circuit configuration example of a limit switch.

### DESCRIPTION OF EMBODIMENTS

Embodiments of the invention are described below with reference to the drawings.

Note that, through the drawings, the same reference numerals denote the same or corresponding components.

### First Embodiment

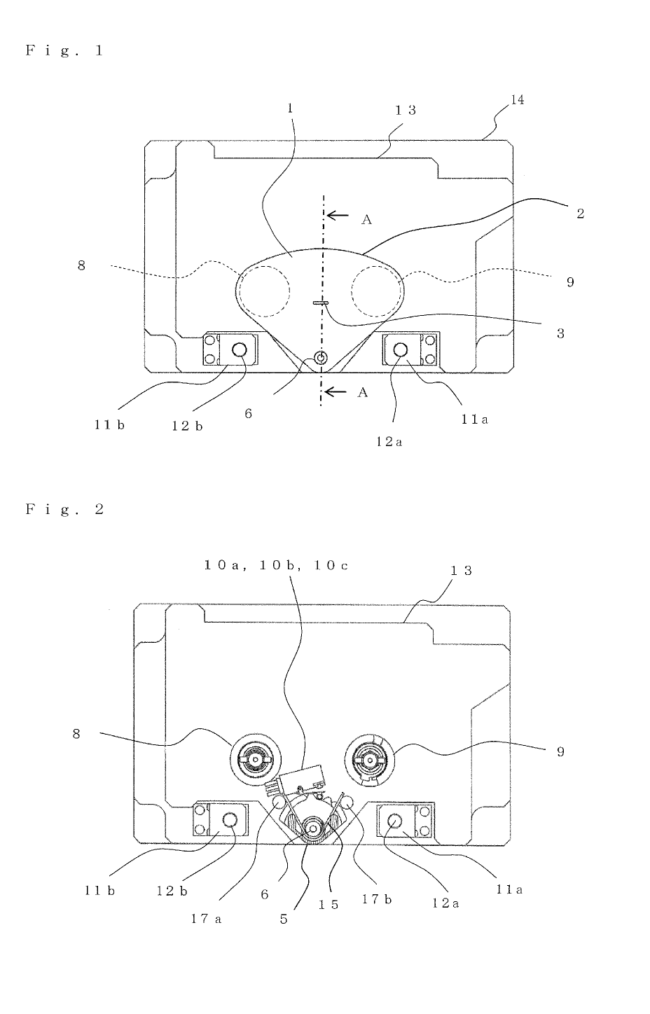

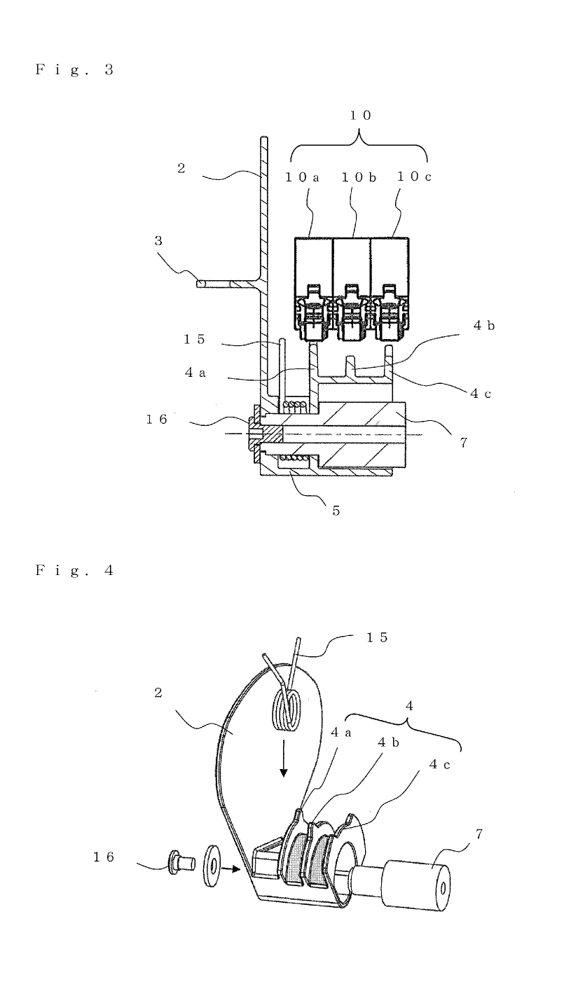

FIG. 1 is a front view showing a three-position switch operating mechanism in accordance with a first embodiment of the invention. FIG. 2 is a front view in which a shutter plate 2 is removed from FIG. 1. FIG. 3 is a cross-sectional view taken along the line A-A in FIG. 1.

Referring to FIGS. 1 to 3, a shutter mechanism 1 includes: the shutter plate 2; a lever 3; cams 4 placed in parallel to the shutter plate 2 and having individually different outer circumference shapes (hereinafter, a first cam, a second cam and a third cam are referred to as “mode switching plate 4a,” “mode switching plate 4b” and “mode switching plate 4c,” respectively); a spring retainer 5 placed between the shutter plate 2 and the mode switching plate 4a; a return spring 15 retained by the spring retainer 5; and the like, all of which are integrally formed of a non-magnetic metal, and an attachment part 6 is fixed to a swing shaft 7. Then, swinging the lever 3 clockwise and counterclockwise can swing the shutter plate 2 clockwise (in one direction) and counterclockwise (in reverse direction) about the swing shaft 7. When switching operation of a disconnecting switch (not shown) or an earthing switch (not shown) is not performed, the shutter 2 is placed so as to hide (cover) a first operating part (hereinafter referred to as “disconnecting switch operating part”) 8 and a second operating part (hereinafter referred to as “earthing switch operating part”) 9.

At this time, the swing of the shutter plate 2 is limited by plungers 12a and 12b described later.

A stationary plate 13 is a part of the mechanism body included in a three-position switch operating mechanism 14 and is mounted and fixed to a frame or the like of the three-position switch operating mechanism 14.

The stationary plate 13 has: limit switches 10 (a first limit switch 10a, a second limit switch 10b and a third limit switch 10c) for operating a contact depending on the swing angle of the above-described mode switching plates 4a, 4b and 4c; an interlock coil 11a for disconnecting switch; an interlock coil 11b for earthing switch; and the plungers 12a and 12b driven by energizing the coils 11a and 11b, respectively, placed thereon.

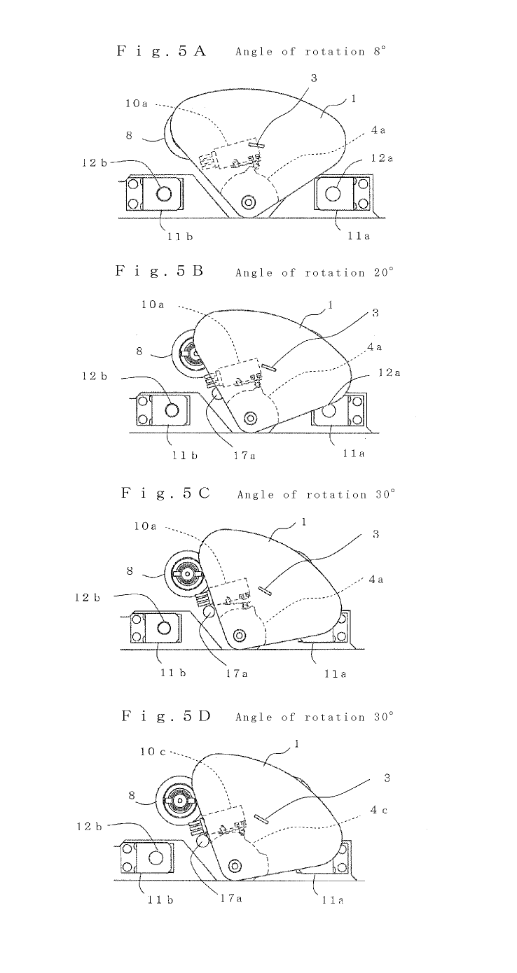

FIG. 5 illustrates an operation angle of the shutter plate 2 when the disconnecting switch is operated.

When the disconnecting switch is to be operated, as shown in FIG. 5(a), the lever 3 is swung clockwise by an angle of 8-25° to cause the mode switching plate 4a to close the contact of the limit switch 10a to energize the interlock coil 11a for disconnecting switch. This pulls the plunger 12a into the coil to release the shutter plate 2 from the interference (limitation) by the plunger 12a and allow the shutter plate 2 to be swung clockwise again.

When the shutter plate 2 is swung by an angle of 25-30°, the mode switching plate 4a opens the contact of the limit switch 10a to de-energize the interlock coil 11a for disconnecting switch, causing the plunger 12a to be returned.

As shown in FIG. 5(c), when the shutter plate 2 is swung by an angle of 30° or more, the disconnecting switch operating part 8 is completely exposed, allowing the disconnecting switch to be operated. At this time, as shown in FIG. 5(d), the mode switching plate 4c closes the contact of the limit switch 10c, the state of which can be indicated by configuring a circuit as shown in FIG. 7 and using a relay for detecting that the disconnecting switch is being operated.

Note that, by configuring so that the contact of the limit switch 10a is closed only when the shutter plate 2 is swung by an angle of 8-25°, when the interlock coil 11a for disconnecting switch satisfies an interlock condition that the earthing switch is in off state, the coil is prevented from being constantly energized to generate heat.

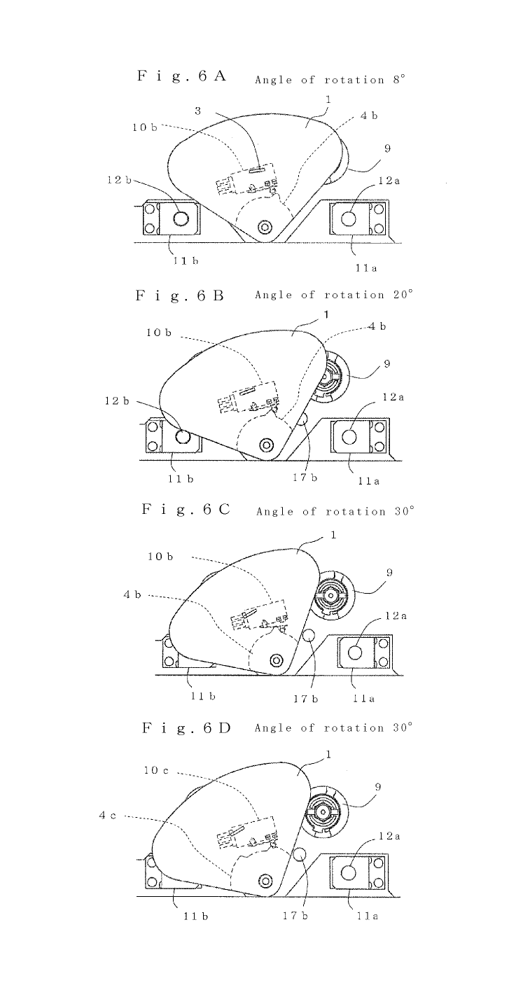

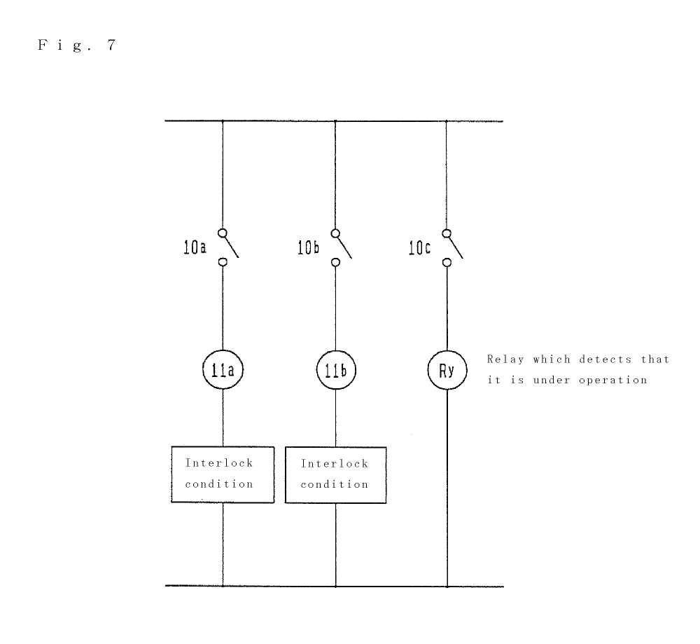

With the disconnecting switch in on state, even when the shutter plate 2 is swung counterclockwise in order to expose the earthing switch operating part 9, the electrical interlock is not unlocked at a swing angle of 8-25°, and, as shown in FIG. 6(b), at a swing angle of 20°, the swing is prevented by the plunger 12b for the interlock coil 11b for earthing switch.

By providing a circuit shown in FIG. 7, the electrical interlock of the interlock coil 11b for earthing switch is configured to be locked when the corresponding interlock condition is that the disconnecting switch is in on state, and configured to be unlocked when the corresponding interlock condition is that the disconnecting switch is in off state.

FIG. 6 illustrates an operation angle of the shutter plate 2 when the earthing switch is operated.

When the earthing switch is to be operated, as shown in FIG. 6(a), the lever 3 is swung counterclockwise by an angle of 8-25° to cause the mode switching plate 4b to close the contact of the limit switch 10b to energize the interlock coil 11b for earthing switch. This pulls the plunger 12b into the coil to release the shutter plate 2 from the interference (limitation) by the plunger 12b and allow the shutter plate 2 to be swung counterclockwise again.

When the shutter plate 2 is swung by an angle of 25-30°, the mode switching plate 4b opens the contact of the limit switch 10b to de-energize the interlock coil 11b for disconnecting switch, causing the plunger 12b to be returned. When the shutter plate 2 is swung by an angle of 30° or more, the earthing switch operating part 9 is completely exposed, allowing the earthing switch to be operated. At this time, as shown in FIG. 6(d), the mode switching plate 4c closes the contact of the limit switch 10c, the state of which can be indicated by configuring a circuit as shown in FIG. 7 and using a relay for detecting that the earthing switch is being operated.

Note that, by configuring so that the contact of the limit switch 10b is closed only when the shutter plate 2 is swung by an angle of 8-25°, when the interlock coil 11b for earthing switch satisfies an interlock condition that the disconnecting switch is in off state, the coil is prevented from being constantly energized to generate heat.

With the earthing switch in on state, even when the shutter plate 2 is swung clockwise in order to expose the disconnecting switch operating part 8, the electrical interlock is not unlocked at a swing angle of 8-25°, and, as shown in FIG. 5(b), at a swing angle of 20°, the swing is prevented by the plunger 12a for the interlock coil 11a for disconnecting switch.

By providing a circuit shown in FIG. 7, the electrical interlock of the interlock coil 11a for disconnecting switch is configured to be locked when the corresponding interlock condition is that the earthing switch is in on state, and configured to be unlocked when the corresponding interlock condition is that the earthing switch is in off state.

According to the first embodiment, the shutter functions of the disconnecting switch operating part 8 and the earthing switch operating part 9 are integrated into the shutter mechanism 1, allowing the number of parts to be reduced. Furthermore, the operation parts of the shutter mechanism 1 is integrated to the lever 3, allowing simpler operation.

Furthermore, the shutter plate 2 is integrally formed to eliminate backlash between parts, which can improve the reliability of contact operation of the limit switches 10a, 10b and 10c by the mode switching plates 4a, 4b and 4c.

Note that the shutter plate 2 is formed of a non-magnetic metal so as not to be affected by magnetic flux from the interlock coil 11a for disconnecting switch or the interlock coil 11b for earthing switch.

A conventional shutter is configured to operate the contact by arc motion of the shutter directly coupled to a cam switch. So, in operating the contact at a predetermined earthing position by interlock, the operation angle is limited by the internal cam shape of the cam switch. Furthermore, when the cam switch cannot be used, a mode switching plate and a limit switch need to be used to operate the contact at any appropriate position, which raises problems of increase in the number of parts and backlash between parts. However, the first embodiment can solve these problems.

### Second Embodiment

FIG. 4 is an exploded perspective view of an assembled shutter in accordance with a second embodiment.

In FIG. 4, a return spring 15 is retained by a spring retainer 5 on a swing shaft 7, and a shutter plate 2 is fixed to the swing shaft 7 by a fixing screw 16.

When the shutter plate 2 is swung clockwise and counterclockwise, the return spring 15 is received and compressed by return spring supporting parts 17a and 17b, so, after operating the disconnecting switch or the earthing switch, the shutter plate 2 can be returned to the initial state by the return spring 15.

According to the second embodiment, the spring retainer 5 is integrally formed with and between the shutter plate 2 and a mode switching plate 4a, so the return spring 15 can be mounted by vertically placing the return spring 15 onto the spring retainer 5 then inserting the swing shaft 7 into an attachment part 6, which can simplify fabrication.

### INDUSTRIAL APPLICABILITY

The invention is useful for providing an operating mechanism having an effect of improving operability and allowing any appropriate contact operating position to be set.

1-8. (canceled)

9. An operating mechanism comprising:
a shutter plate that is swingably supported by a swing shaft held by a mechanism body, and covers both a first operating part and a second operating part placed in parallel to each other on the mechanism body; and
a shutter mechanism that, in exposing the first operating part to operate the first operating part, swings the shutter plate in one direction and, in exposing the second operating part to operate the second operating part, swings the shutter plate in reverse direction,
wherein the shutter mechanism comprises:
one pair of locking members for limiting or releasing the swing of the shutter plate:
first and second cams that move in conjunction with the shutter plate; and
first and second limit switches that are opened and closed by the first and second cams, respectively, to control the protruding/retracting operation of one pair of plungers that can be protruded and retracted with respect to the shutter plate,
wherein both the plungers normally limit the swing of the shutter plate to maintain the first operating part and the second operating part covered,
and wherein, in operating the first operating part or the second operation part, in order to expose the operation part to be operated, when the shutter plate reaches a predetermined swing angle, the plunger for the operation part to be operated is retracted by the first cam and first limit switch or the second cam and second limit switch to release the limitation of the swing of the shutter plate.

10. The operating mechanism according to claim 9, wherein an operating spring for returning the shutter plate to the position for covering both the operating parts is provided on the swing shaft.

11. The operating mechanism according to claim 9, wherein the plunger is protruded/retracted by an interlock coil that is energized/de-energized by opening/closing the corresponding limit switch.

12. The operating mechanism according to claim 10, wherein the plunger is protruded/retracted by an interlock coil that is energized/de-energized by opening/closing the corresponding limit switch.

13. The operating mechanism according to claim 11, wherein, when the first operating part or the second operation part is completely exposed, the interlock coil is de-energized by the first cam and first limit switch or the second cam and second limit switch.

14. The operating mechanism according to claim 12, wherein, when the first operating part or the second operation part is completely exposed, the interlock coil is de-energized by the first cam and first limit switch or the second cam and second limit switch.

15. The operating mechanism according to claim 9, wherein a third cam and a third limit switch for, when the first operating part or the second operating part is exposed, indicating that the exposed operating part is operating are provided to the shutter mechanism.

16. The operating mechanism according to 15, wherein the shutter plate and the first, second and third cams are integrally formed and fitted over the swing shaft.
